(19) United States
(12) Patent Application Publication
(10) Pub. No.: US 2014/0014510 A1
(43) Pub. Date: Jan. 16, 2014

(54) Two-electrode Corrosion Probe

(71) Applicants: Stefan Ehmele, Visp (CH); Wolfgang Schuhmann, Bochum (DE); Fabio La Mantia, Bochum (DE); Maike Pähler, Bochum (DE); Hans-Peter Nirmaier, Visp (CH)

(72) Inventors: Stefan Ehmele, Visp (CH); Wolfgang Schuhmann, Bochum (DE); Fabio La Mantia, Bochum (DE); Maike Pähler, Bochum (DE); Hans-Peter Nirmaier, Visp (CH)

(21) Appl. No.: 13/738,389

(22) Filed: Jan. 10, 2013

Related U.S. Application Data
(60) Provisional application No. 61/670,896, filed on Jul. 12, 2012.

(51) Int. Cl. G01N 17/02

(52) U.S. Cl. CPC G01N 17/02
USPC 204/404

(57) ABSTRACT

A two-electrode corrosion probe having a probe shaft and a probe head connected to the probe shaft, a counter-electrode, a replaceable working electrode which is arranged at a distance from the counter-electrode between the probe shaft and the probe head. The probe also includes a first contact-making element and a second contact-making element which are arranged in the probe shaft, where the probe head is formed from a sleeve body and has a supporting structure to which the counter-electrode is fastened. The first contact-making element is electrically connected to the working electrode and the second contact-making element is electrically connected to the counter-electrode via a connecting element.

This application is based on, and Applicants claim priority from, U.S. Provisional Application bearing Ser. No. 61/670,896 filed Jul. 12, 2012, the disclosure of which is incorporated herein by reference.

### BACKGROUND OF THE INVENTION

The present invention relates to a two-electrode corrosion probe and, in particular, to a two-electrode corrosion probe for use in electrochemical impedance spectroscopy, in which case the term “corrosion” is understood as meaning “any” reaction between an electrically conductive material and its environment, which reaction causes a measurable change in the material and may result in the function of a component or a system being impaired.

Conventional corrosion probes have the disadvantage that, owing to the design, they require a large measuring volume and the sample which is corroded can be replaced only laboriously.

Therefore, one object of the present invention is to eliminate the problem and to provide a corrosion probe which is compact and in which the samples to be corroded can be easily and quickly replaced. Another object of the present invention is to ensure exact reproducibility of measurements.

### DESCRIPTION OF THE INVENTION

These objects are achieved by means of the teaching in Claim 1.

According to the present invention (Claim 1), a two-electrode corrosion probe has: a probe shaft and a probe head connected to the probe shaft, a counter-electrode, a replaceable working electrode which is arranged at a distance from the counter-electrode between the probe shaft and the probe head, and a first contact-making element and a second contact-making element which are arranged in the probe shaft, where the probe head is formed from a sleeve body and has a supporting structure to which the counter-electrode is fastened, and the first contact-making element is electrically connected to the working electrode and the second contact-making element is electrically connected to the counter-electrode via a connecting element.

The two-electrode corrosion probe according to the present invention thus comprises exactly two electrodes, the working electrode (material sample) and the counter-electrode. However, the probe can be expanded to form a three-electrode corrosion system by adding a further, external electrode (for example a reference electrode which is preferably in the form of a Luggin capillary), which system contains the two-electrode corrosion probe according to the present invention but, in its entirety, does not form the present invention. It should also be noted that the term “probe” according to the present invention can also be understood in the sense of “simulator”, as stated further below. According to the present invention, the term “probe shaft” means that the claimed two-electrode corrosion probe preferably has substantially the shape of an elongate cylinder, preferably an elongate circular cylinder, in which case a connecting axis, along which the probe head and the probe shaft are arranged and are connected to one another, is the longitudinal axis of the cylinder. However, the two-electrode corrosion probe is not restricted to this structure. Rather, the two-electrode corrosion probe according to the present invention can also be in the form of a disk, with the result that the width of said cylinder is greater than its length. According to the present invention, the term “probe head” means that this component of the claimed two-electrode corrosion probe preferably has a shorter extent along the connecting axis than the probe shaft. However, this is not necessarily the case. Rather, the extents of the probe shaft and of the probe head are independent of one another, with the result that both terms are used only to delimit their respective functionality from one another, as stated further below. According to the present invention, the working electrode is arranged at a distance from the counter-electrode between the probe shaft and the probe head. In this case, said distance is the distance along the connecting axis. The working electrode, which is preferably a solid body in the form of a disk, preferably in the form of a circular disk, and the counter-electrode, which is in the form of a mesh or grid, are each substantially planar and are arranged with respect to one another in such a manner that their respective normal vectors are substantially parallel/antiparallel with respect to the connecting axis.

The areas of the working electrode and of the counter-electrode are advantageously substantially the same, with the result that an electrical field produced between them by applying an electrical voltage is substantially homogeneous apart from boundary regions. In this case, “area of the electrode” should be understood as meaning the unclamped, that is to say free, surface facing the respective other electrode, which, in the case of a mesh-like or grid-like electrode, is the area of the projection of the mesh or grid, including the areas of the holes. Alternatively, the outer circumferential edges of projections of the working electrode and of the counter-electrode onto a plane perpendicular to the connecting axis are mathematically similar to one another to the effect that they can be produced by means of geometrical stretching apart. The counter-electrode according to the present invention need not necessarily be circular, but rather may also be oval or in the form of a strip. Furthermore, the shape of the counter-electrode may be different from that of the working electrode according to the present invention. According to the present invention, the distance between the working electrode and the counter-electrode is preferably as short as possible but is not equal to zero in order to thus realize the desired homogeneous electrical field as ideally as possible with simultaneously undisrupted supply and discharge of the electrolyte. In order to meet the homogeneity requirement described above, the distance between the working electrode and the counter-electrode can be selected to be greater, the greater the area of the smaller electrode. The area of the working electrode and of the counter-electrode is preferably respectively approximately 0.5 cm² to 5 cm² and their distance is preferably 5 mm to 20 mm. According to the present invention, the probe head is formed from a sleeve body. In this case, a sleeve is understood as meaning a generally tubular element, that is to say an element with a through-opening, in which case the wall of the sleeve may have various structures such as projections, openings etc. In particular, the sleeve body has a supporting structure to which the counter-electrode is fastened. The supporting structure is preferably formed from two mutually opposite, columnar projections or extensions of the sleeve wall which extend in the direction of the longitudinal axis of the sleeve and away from the working electrode. Alternatively, the supporting structure may likewise be in the form of a sleeve and may thus form, together with the working electrode, a space which is filled with electrolyte in the operating state and in which the counter-electrode is arranged. According to the present invention, the first contact-making element is electrically connected to the working electrode, in which case this connection is preferably direct, while the second contact-making element is indirectly electrically connected to the counter-electrode via the connecting element which is electrically connected between the second contact-making element and the counter-electrode, with the result that the second contact-making element, the connecting element and the counter-electrode are electrically connected in series. The indirect contact-making operation is preferably resiliently carried out automatically during assembly (cf. Claim 11).

The contact-making elements according to the present invention are used to apply a well-defined voltage signal, preferably by connecting the contact-making elements to a suitable signal generator. The contact-making elements according to the present invention are therefore current supply and discharge elements which establish an electrical connection between a voltage source and the working electrode or counter-electrode. According to the present invention, as a result of the fact that both the first contact-making element and the second contact-making element of the claimed two-electrode corrosion probe are arranged in the probe shaft, that is to say in the same end section of the two-electrode corrosion probe according to the present invention, both contact-making elements are guided out of the same end section of the two-electrode corrosion probe on the end face. According to the present invention, both contact-making elements are guided out of the claimed two-electrode corrosion probe on one end face of the latter. Alternatively, said elements may be guided out of said probe on different sides. As a result, the two-electrode corrosion probe is compact, that is to say space-saving. According to the present invention, the claimed two-electrode corrosion probe is used to detect the corrosion behavior of the working electrode which is an electrically conductive material sample, with the result that the term “probe” is justified. As already mentioned above, the probe may also be interpreted as a “simulator” since the corrosion behavior of the working electrode in contact with a well-defined electrolyte, which fills the space between the working electrode and the counter-electrode, is detected and the results are then applied to a situation in which the working electrode does not come into contact with the electrolyte used in the test but rather with another electrolyte or with a gas which causes the corrosion of said electrode. This intended purpose makes it necessary for the working electrode according to the present invention to be replaceable.

According to an advantageous aspect of the present invention (Claim 2), the probe shaft and the probe head are releasably connected to one another in a form-fitting and/or force-fitting manner.

This has the advantage that the probe shaft and the probe head can be easily separated from one another in order to insert or replace the working electrode or for cleaning or repair work. As a result of the fact that the contact-making elements are arranged only in the probe shaft and both the counter-electrode and the connecting elements are arranged only in the probe head, the probe shaft and the probe head are no longer connected to one another by cables or the like after the connection between them has been released but rather form independent units, which facilitates handling. In particular, after the probe shaft has been separated from the probe head, the latter is decoupled from the former not only mechanically but also electrically.

According to an advantageous aspect of the present invention (Claim 3), the releasable connection between the probe shaft and the probe head is a screw connection, a plug connection or a bayonet connection, and, according to another advantageous aspect of the present invention (Claim 4), the probe head formed from a sleeve body engages around a joining or connecting section of the probe shaft and/or sits thereon.

The probe head and the probe shaft can thus be quickly and easily connected and separated and the working electrode (material sample) can thus be quickly and easily replaced. Although the probe head engages around a connecting section of the probe shaft according to said advantageous aspect of the present invention (Claim 4), a converse design in which the probe shaft engages around the probe head is likewise possible. In both cases, the connecting section which is engaged around forms a journal-like projection which extends into a substantially complementary depression in the respective mating part. In order to close the probe shaft in a fluid-tight manner with respect to the electrolyte, seals are provided at appropriate locations and are pressed together to a well-defined extent by virtue of the probe shaft being connected to the probe head in order to thus produce their optimum sealing effect (cf. Claim 10).

According to an advantageous aspect of the present invention (Claim 5), the connecting element comprises an annular first connecting part, which is electrically connected to the second contact-making element, and a second connecting part which is electrically connected between the first connecting part and the counter-electrode.

According to this advantageous aspect, the connecting axis preferably extends through the center point of the annular first connecting part which is formed in an electrically conductive manner, that is to say is preferably formed from metal. This ensures that the second contact-making element makes electrical contact with the first connecting part irrespective of the angular position of the second contact-making element. According to the present invention, the second connecting part is preferably a platinum wire which is sheathed over its entire length with the exception of contact-making end sections. The sheathing is used firstly to reinforce the platinum wire, which is very thin, and secondly to stably fix and position the wire inside a receptacle of the probe head and thirdly for sealing with respect to the electrolyte surrounding the probe head.

According to an advantageous aspect of the present invention (Claim 6), the counter-electrode is releasably fastened to the supporting structure.

Claim 1 according to the present invention defines a distance between the counter-electrode and the working electrode but not their respective shape. Although this shape is preferably circular in each case according to the present invention, other shapes, for instance an oval shape, a polygonal shape, a strip shape etc., are possible, as already mentioned above. It is indeed also advantageous, but not compulsory, for the working electrode to have the same shape as the counter-electrode, as already mentioned above. Therefore, according to the present invention, it is possible to remove or replace the counter-electrode, which is expedient, in particular, when the counter-electrode used is damaged or its function is impaired in another manner or in order to have better access to the working electrode.

According to an advantageous aspect of the present invention (Claim 7), the counter-electrode is fastened to the supporting structure by means of a screw connection.

Alternatively, the counter-electrode can also be fastened to the supporting structure by means of a clamping connection or a plug connection or the like. According to an advantageous refinement of the present invention, the counter-electrode has holes through which screws or threaded sleeves or other fastening means such as pins are guided. In the case of screws or threaded sleeves, the counter-electrode is preferably easily fastened in such a manner that it rests against the supporting structure by means of the screw heads or nuts.

According to an advantageous aspect of the present invention (Claim 8), the second connecting part is arranged in the supporting structure and is fastened in a threaded hole in the supporting structure by means of an inner threaded sleeve and an outer threaded sleeve at a distance from the inner threaded sleeve, and the counter-electrode is fastened to the outer threaded sleeve with the aid of a nut.

At least the inner threaded sleeve is advantageously used to fix the position of, and fasten, the second connecting part in the threaded hole, and the outer threaded sleeve is used at least to fasten the counter-electrode. The advantage over a single threaded sleeve is that loosening and/or maladjustment of the second connecting part which has already been exactly positioned, which is also effected with regard to an effective seal (cf. Claim 10), is avoided to the greatest possible extent when replacing the counter-electrode by releasing the nut. The nut used can be any desired nut, for instance a “conventional” nut or a dome nut. The second connecting part advantageously rests in a resiliently prestressed manner on the first connecting part and is advantageously held in this resiliently prestressed position by means of a seal which is prestressed in the axial direction of the second connecting part and is thus extended in the radial direction. According to the present aspect, both the inner threaded sleeve and the outer threaded sleeve are arranged in a single threaded hole which is inevitably continuous in terms of assembly. Alternatively, an inner threaded hole, in which the inner threaded sleeve is arranged, and an outer threaded hole, in which the outer threaded sleeve is arranged, may be provided, the diameter of the inner threaded hole being smaller than that of the outer threaded hole.

According to an advantageous aspect of the present invention (Claim 9), a supporting element is arranged between the probe shaft and the working electrode, through which supporting element the first contact-making element extends to the working electrode, and which supporting element keeps the working electrode in contact with a bearing surface of the probe head.

According to this advantageous aspect, the bearing surface is in the form of at least one projection of the sleeve-like probe head, which projection projects with respect to the connecting axis and is preferably annular. The supporting element is used to hold or fix the working electrode while connecting the probe head to the probe shaft.

According to an advantageous aspect of the present invention (Claim 10), a seal is respectively arranged between the working electrode and the bearing surface, between end faces of the probe head and of the probe shaft which are in direct contact and between the inner threaded sleeve and the probe head.

According to an advantageous aspect of the present invention (Claim 11), the first and second contact-making elements are respectively resiliently prestressed against the working electrode and the first connecting part.

In this manner, the probe head and the probe shaft can be easily mechanically connected to one another after the working electrode has been inserted, the electrical contact-making process being carried out automatically by virtue of the contact-making elements being pressed together counter to the spring force when joining the probe shaft and probe head, with the result that there is no need for any subsequent adjustment of the contact-making elements, for example. The contact-making elements are therefore each arranged in a displaceable manner in a corresponding through-opening in the probe shaft. This means that at least such a force as is needed to overcome the prestressing force of the contact-making elements and the compression of the seals is needed to connect the probe head to the probe shaft.

According to an advantageous aspect of the present invention (Claim 12), the ratio of the area of the counter-electrode to the area of the working electrode is at least 80%.

A ratio of 100% is preferable but not compulsory. Different sizes and/or shapes cause “distortion” of the electrical field between the working electrode and the counter-electrode and thus reduce its homogeneity. In particular, the ratio of the area of the counter-electrode to the area of the working electrode may also be greater than 100% since the counter-electrode can theoretically have an infinite extent and, in principle, can have a very much greater extent than the working electrode in practice.

According to an advantageous aspect of the present invention (Claim 13), the counter-electrode is in the form of a mesh or grid.

This property of the counter-electrode improves the exchange of electrolyte to and from the working electrode. In the case of a closed supporting structure in the form of a sleeve (cf. comments made with respect to claim 1) and a counter-electrode extending perpendicular to the connecting axis over the entire cross section, electrolyte interchange is only enabled by the structure in the form of a mesh or grid. In this respect, a “mesh” differs only slightly from a “grid”, the latter having greater rigidity. According to the present invention, the counter-electrode is preferably formed from platinum or coated with platinum.

According to an advantageous aspect of the present invention (Claim 14), the distance between the working electrode and the counter-electrode can be set.

This has the advantage that the measurement accuracy and sensitivity of the two-electrode corrosion probe according to the present invention can be adapted to different test parameters, for instance the material and the size (in particular the thickness) of the working electrode, the electrolyte used and the like, and its effect can therefore be optimized.

According to an advantageous aspect of the present invention (Claim 15), the probe shaft and the probe head are each formed from an electrically non-conductive material.

The two-electrode corrosion probe according to the present invention makes it possible to carry out any desired electroanalytical experiments, for instance potentiodynamic polarization experiments for determining the corrosion potential on the basis of the composition of the solution and the temperature. In particular, there are no restrictions on the material of the working electrode apart from its electrical conductivity, that is to say the material is not limited, for example, to metal materials, for example steel, aluminum or copper. Complex sequences of potential pulses/current pulses in conjunction with electrochemical impedance spectroscopy make it possible to shorten the test time in comparison with conventional corrosion probes, with the result that quick statements can be made with regard to the properties of the working electrode. The measuring time is also reduced by virtue of the fact that evaluations of measurements are simplified by the arrangement and planar design of the working electrode and of the counter-electrode. It should be noted that a planar design also has the advantage that the corrosion processes likewise take place in a planar manner, which results in a faster change in the measurement signal and, with a comparable measuring time, to a more distinct corrosion effect in comparison with corrosion at specific points or local corrosion. The more distinct corrosion effect is in turn advantageous with regard to the accuracy which can be achieved during the subsequent weighing of the working electrode.

### BRIEF DESCRIPTION OF THE DRAWINGS

Further advantages and features of the present invention become clear from the following detailed description in conjunction with the accompanying drawings, in which:

FIGS. 1A and 1B are longitudinal section views of an end section of a two-electrode corrosion probe having a probe head and a probe shaft (only one end section of which is shown) connected to the probe head according to a first and a second embodiment of the present invention;

FIG. 2 is a longitudinal section view of a two-electrode corrosion probe according to a third embodiment of the present invention, the front (upper in FIG. 2) end section of which is illustrated in a slightly modified form in FIGS. 1A and 1B; and

FIG. 3 is a schematic plan view (FIG. 3A), a schematic perspective view (FIG. 3B) and a schematic side view (FIG. 3C) of a two-electrode corrosion probe according to a third embodiment of the present invention.

### DETAILED DESCRIPTION OF THE DRAWINGS

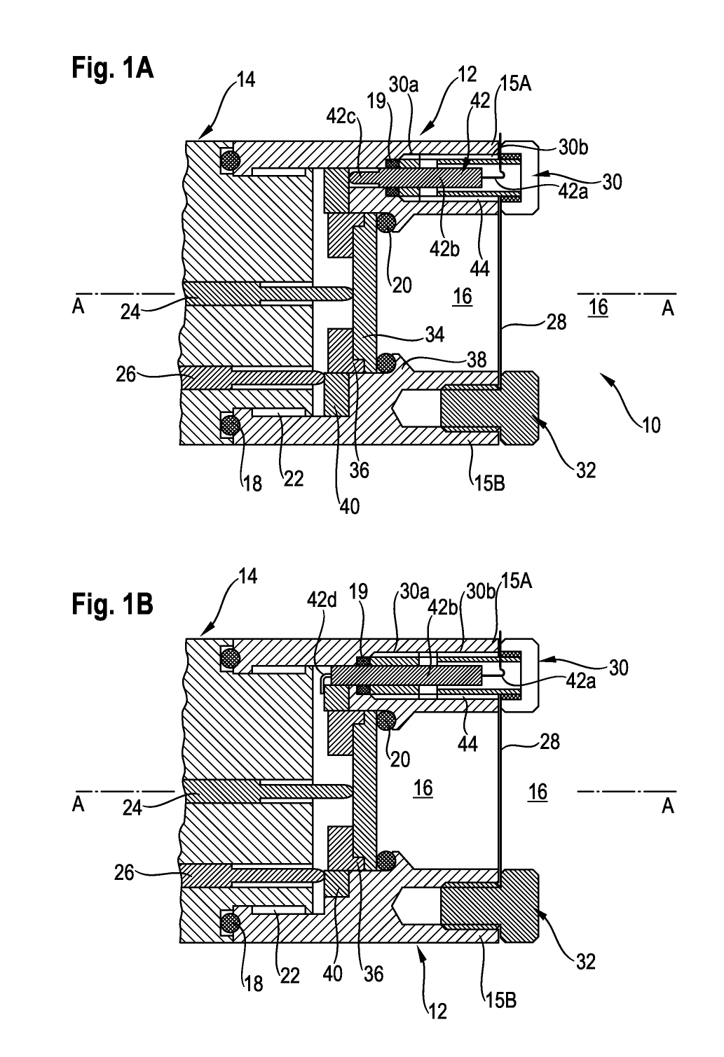

FIG. 1A shows a longitudinal section view of a section of a two-electrode corrosion probe 10 according to a first embodiment of the present invention having a probe head 12 formed from a sleeve body and a generally cylindrical probe shaft 14 connected to the probe head 12. The probe shaft 12 has a supporting structure 15 formed in the form of a first columnar element 15A and a second columnar element 15B. In the state shown in FIG. 1 (operating or measuring state), the probe shaft 14 is sealed with respect to the outer region 16, in which an electrolyte is situated in this state, by means of O-ring seals 18, 19 and 20. The probe shaft 14 and the probe head 12 are releasably connected to one another via a screw connection 22. A first pin-like contact-making element 24 and a second pin-like contact-making element 26 are resiliently accommodated and guided in the probe shaft 14. A reticular counter-electrode 28 in the form of a strip is fastened to the columnar elements 15A, 15B by means of a first screw connection 30 and a second screw connection 32. A working electrode 34 in the form of a circular disk is arranged between the probe head 12 and the probe shaft 14. On its left-hand side in FIG. 1, the working electrode 34 is in contact with a supporting element 36 in the form of a circular ring and, on its right-hand side in FIG. 1, the working electrode is in contact with the seal 20. The seal 20 is in turn on a circular projection 38 of the probe head 12, which projection projects into the interior of the probe head 12. The supporting element 36 is surrounded by an annular, metal first connecting part 40. The following arrangement thus arises inside the probe head 12 and along a connecting or arrangement axis A from right to left in FIG. 1: counter-electrode 28—projection 38—seal 20—working electrode 34—supporting element 36 (surrounded by the first connecting part 40)—probe shaft 14. The first contact-making element 24 is prestressed with respect to the center of the working electrode 34 by means of a spring (not shown). The second contact-making element 26 is prestressed with respect to the first connecting part 40 by means of a spring (not shown). A second connecting part 42 establishes an electrically conductive connection between the first connecting part 40 and the counter-electrode 28. The first contact-making element 24 is thus electrically directly connected to the working electrode 34, while the second contact-making element 26 is electrically connected to the counter-electrode 28 via the first connecting part 40 and the second connecting part 42, with the result that a substantially homogeneous electrical field is produced between the counter-electrode 28 and the working electrode 34 by means of a voltage applied between the contact-making elements 24, 26. The connecting element 42 is arranged in the first columnar supporting element 15A and comprises a platinum wire 42a which is embedded in a glass sheath 42b and, for the purpose of making contact with the first connecting part 40, is connected to a third contact-making element 42c. The connecting element 42 is fixed in position in a threaded hole 44 in the columnar supporting element 15A in as fluid-tight a manner as possible with the aid of an inner (that is to say arranged deeper in the threaded hole 44) threaded sleeve 30a with an outer thread and an inner hole and an outer (that is to say arranged less deep in the threaded hole 44) threaded sleeve 30b with an outer thread and an inner hole. The fluid-tightness is supported by the seal 19 which is compressed by the inner threaded sleeve 30a. As can be seen in FIG. 1A, the inner and outer threaded sleeves 30a, 30b are at a distance from one another. The counter-electrode 28 extends from the first columnar supporting element 15A, where the outer threaded sleeve 30b extends from it through an opening and where it is fastened to the first columnar supporting element 15A by means of a nut of the first screw connection 30, to the second columnar supporting element 15B, where a screw of the second screw connection 32 extends from it through a further opening and where it is fastened to the second columnar supporting element 15B by means of a screw head of the screw of the second screw connection 32. That is to say, the first screw connection 30 has the threaded hole 44 in the first columnar supporting element 15A, the inner and outer threaded sleeves 30a, 30b and the nut, and the second screw connection 32 has the threaded hole in the second columnar supporting element 15B and the screw accommodated in the latter.

In order to insert or replace the working electrode (sample) 34, the screw connection 22 is released, that is to say the probe head 12 is rotated with respect to the probe shaft 14. As a result of the fact that the contact-making elements 24, 26 are resiliently prestressed with respect to the working electrode 34 and the first connecting part 40, said elements first of all still remain in mechanical contact which is released only as the distance between the probe head 12 and the probe shaft 14 becomes greater. In the completely separated state, the probe head 12, including the working electrode 34 accommodated in the latter, is mechanically and electrically decoupled from the probe shaft 14 containing the contact-making elements 24, 26. It is thus possible to easily insert or replace the working electrode 34. It should be noted that the angular position between the probe head 12 and the probe shaft 14 need not be exactly defined, which often also cannot be done with a screw connection since the first contact-making element 24 makes contact with the working electrode 34 in the center and the second contact-making element 26 is guided along the annular connecting part 40 during connection (screwing-in).

FIG. 1B shows a longitudinal section view of a section of a two-electrode corrosion probe 10 according to a second embodiment of the present invention. The section shown corresponds to the section shown in FIG. 1A and differs only in the manner in which contact is made between the second connecting part 42 and the first connecting part 40. According to the second embodiment, the contact-making pin 42 is replaced with an L-shaped contact-making electrode 42d which engages around the first connecting part 40 which, in this respect, does not extend as far as the sleeve-shaped section of the probe head 12 or provides a corresponding recess.

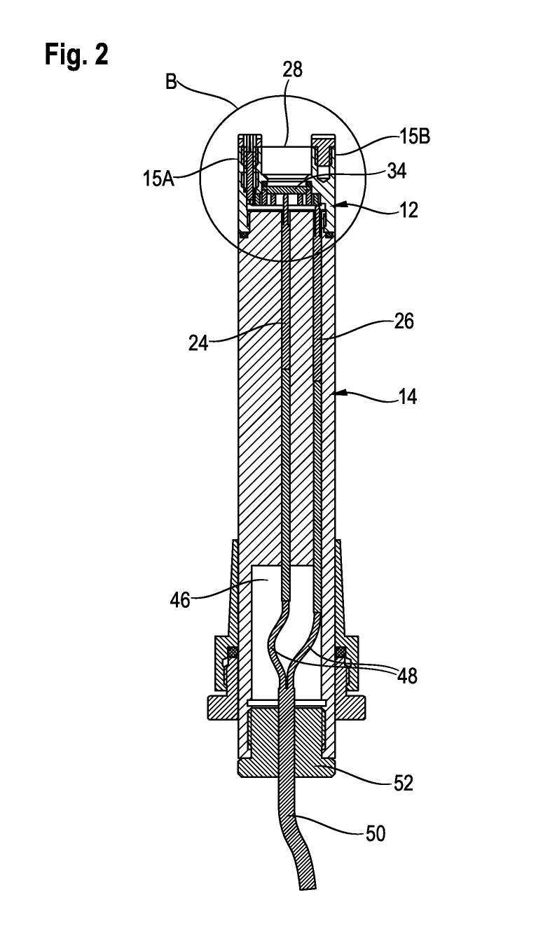

FIG. 2 shows a longitudinal section view of a two-electrode corrosion probe according to a third embodiment of the present invention, the front (upper in FIG. 2) end section of which is illustrated in a slightly modified form in FIGS. 1A and 1B. It should be noted that, in contrast to FIG. 2, only part of the probe shaft 14 is shown in FIGS. 1A and 1B, that is to say only the connecting end section which is connected to the probe head 12. FIG. 2 shows how the probe shaft 14 extends to the rear (downward in FIG. 2), the contact-making elements 24, 26 being connected, in a recess 46 of the probe shaft 14, to lines 48 which are then joined to form a common line 50 which is routed to the outside through a cap 52.

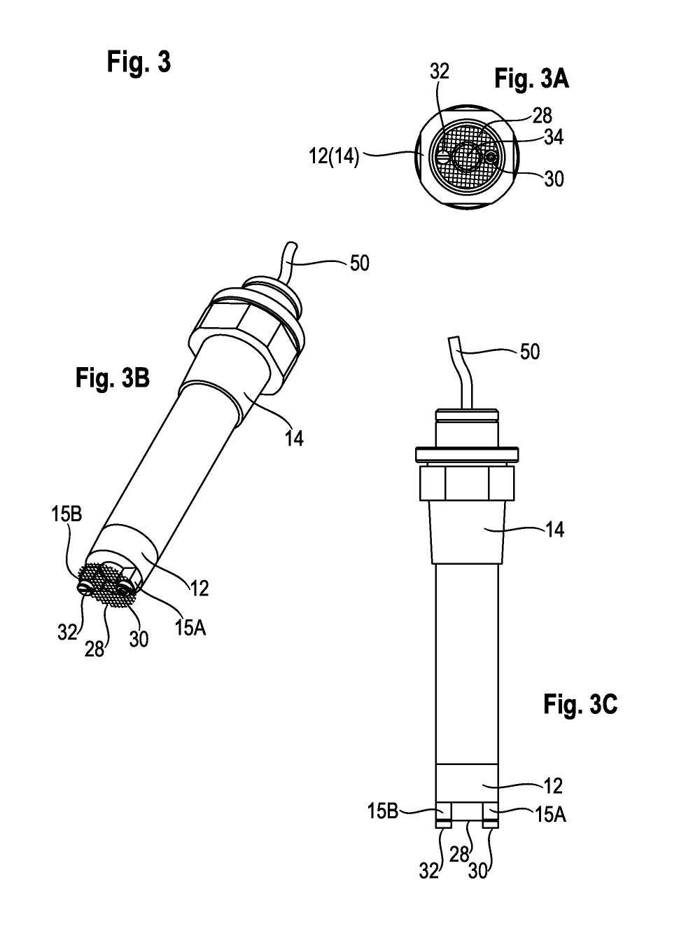

FIG. 3 shows a schematic plan view (FIG. 3A), a schematic perspective view (FIG. 3B) and a schematic side view (FIG. 3C) of a two-electrode corrosion probe according to a third embodiment of the present invention. In particular, FIG. 3A is a view of the counter-electrode 28 which is in the form of a circular mesh according to this embodiment.

### LIST OF REFERENCE SYMBOLS

10 Two-electrode corrosion probe
12 Probe head
14 Probe shaft
15 Supporting structure
15A, 15B Columnar elements of 15
16 Outer region of 10
18 O-ring seal
19 O-ring seal
20 O-ring seal
22 Screw connection
24 First contact-making element
26 Second contact-making element
28 Counter-electrode
30 First screw connection
30a Inner threaded sleeve
30b Outer threaded sleeve
32 Second screw connection
34 Working electrode
36 Supporting element
38 Projection
40 First connecting part
42 Second connecting part
42a Platinum wire
42b Glass sheath
42c Third contact-making element
42d Contact-making electrode
44 Threaded hole in 15A
46 Recess
48 Lines
50 Common line
52 Cap

A Connecting axis

B Region

Thus, while there have been described what are presently believed to be the preferred embodiments of the invention, those skilled in the art will realize that changes and modifications may be made thereto without departing from the spirit of the invention, and it is intended to include all such changes and modifications as fall within the true scope of the invention as set forth in the following claims.

1. Two-electrode corrosion probe comprising:
a probe shaft and a probe head connected to the probe shaft;
a counter-electrode;
a replaceable working electrode which is arranged at a distance from the counter-electrode between the probe shaft and the probe head; and
a first contact-making element and a second contact-making element which are arranged in the probe shaft;
where
the probe head is formed from a sleeve body and has a supporting structure to which the counter-electrode is fastened; and
the first contact-making element is electrically connected to the working electrode and the second contact-making element is electrically connected to the counter-electrode via a connecting element.

2. Probe according to claim 1, characterized in that the probe shaft and the probe head are releasably connected to one another in a form-fitting and/or force-fitting manner.

3. Probe according to claim 2, characterized in that the releasable connection between the probe shaft and the probe head is a screw connection, a plug connection or a bayonet connection.

4. Probe according to claim 1, characterized in that the probe head engages around a connecting section of the probe shaft or sits on the connecting section.

5. Probe according to claim 1, characterized in that the connecting element comprises an annular first connecting part, which is electrically connected to the second contact-making element, and comprises a second connecting part which is electrically connected between the first connecting part and the counter-electrode.

6. Probe according to claim 5, characterized in that the counter-electrode is releasably fastened to the supporting structure.

7. Probe according to claim 6, characterized in that the counter-electrode is fastened to the supporting structure by means of a screw connection.

8. Probe according to claim 7, characterized in that the second connecting part is arranged in the supporting structure and is fastened in a threaded hole in the supporting structure by means of an inner threaded sleeve and an outer threaded sleeve at a distance from the inner threaded sleeve, and in that the counter-electrode is fastened to the outer threaded sleeve with the aid of a nut.

9. Probe according to claim 1, characterized in that a supporting element is arranged between the probe shaft and the working electrode, through which supporting element the first contact-making element extends to the working electrode, and which supporting element keeps the working electrode in contact with a contact surface of the probe head.

10. Probe according to claim 9, characterized in that a seal is respectively arranged between the working electrode and the bearing surface, between end faces of the probe head and of the probe shaft which are in direct contact and between the inner threaded sleeve and the probe head.

11. Probe according to claim 1, characterized in that the first and second contact-making elements are respectively resiliently prestressed against the working electrode and the first connecting part.

12. Probe according to claim 1, characterized in that the ratio of the area of the counter-electrode to the area of the working electrode is at least 80%.

13. Probe according to claim 1, characterized in that the counter-electrode is in the form of a mesh or grid.

14. Probe according to claim 1, characterized in that the distance between the working electrode and the counter-electrode can be set.

15. Probe according to claim 1, characterized in that the probe shaft and the probe head are each formed from an electrically non-conductive material.
